(19) United States
(12) Patent Application Publication
(10) Pub. No.: US 2019/0376441 A1
(43) Pub. Date: Dec. 12, 2019

(54) Pre-Chamber Spark Plug

(71) Applicant: Caterpillar Inc., Deerfield, IL (US)

(72) Inventor: John R. Brubaker, Battle Ground, IN (US)

(73) Assignee: Caterpillar Inc., Deerfield, IL (US)

(21) Appl. No.: 16/003,272

(22) Filed: Jun. 8, 2018

(51) Int. Cl. F02B 19/12; F02P 13/00; F02B 43/04; H01T 13/32

(52) U.S. Cl. CPC F02B 19/12; H01T 13/32; F02B 43/04; F02P 13/00

(57) ABSTRACT

A spark plug for an internal combustion engine includes a body that includes a terminal post, a central electrode, and a mounting sleeve that includes a threaded portion. A precombustion cavity is defined within the body. A free end of the central electrode extends into the precombustion cavity, and a plurality of posts is disposed through the mounting sleeve at the threaded portion, each of the plurality of posts protruding at least partially into the chamber by a predetermined distance (d). An electrode having one or more limbs is connected to the free end of the central electrode. A cap is disposed to close an open end of the precombustion cavity.

### TECHNICAL FIELD

This patent disclosure relates generally to internal combustion engines and, more particularly, to a pre-chamber spark plug.

### BACKGROUND

Engines operating using a gaseous fuel are typically operated with a lean fuel mixture. The nature of the gaseous fuel, which is often supplied in an intake manifold of the engine before being distributed into engine cylinders in mixture with incoming or charge air, requires a vigorous spark to ignite when in the engine cylinders. The lean fuel mixture used is often challenging to reliably ignite, and often results in incomplete combustion, misfires, detonation, poor fuel economy and the like. The device typically tasked igniting the lean air/fuel mixture in the cylinder is a spark plug. Spark plugs are used, either alone or within a combustion pre-chamber, to ignite a flame, which then propagates into the cylinder or from the pre-chamber as a burning mass provided into the cylinder.

Pre-chamber, or precombustion chamber spark plugs, are sparking devices used in the precombustion chamber of an engine to enhance the lean flammability limits in lean burn engines such as natural gas lean burn engines. One example of a precombustion chamber spark plug can be seen in U.S. Patent Application Pub. No. 2016/0254650 A1 (“Kuhnert”), which is titled “Prechamber Spark Plug” and which describes a precombustion chamber spark plug in which a ground electrode is embodied as a substantially circular cylindrical pin that can be welded into a passage of the spark plug body.

While precombustion chamber spark plugs are at least partially effective in achieving a more reliable ignition of lean air/gaseous fuel mixtures than traditional, open air spark plugs, it is always desirable to improve reliable ignition within engine cylinders.

### SUMMARY

The disclosure describes, in one aspect, a spark plug for an internal combustion engine. The spark plug includes a body having a terminal post adapted for connection to a source of electrical potential. A central electrode is electrically connected to the terminal post. A mounting sleeve includes a threaded portion, wherein the central electrode extends at least partially through the mounting sleeve. An internal insulator is disposed between at least a portion of the central electrode and the mounting sleeve. A precombustion cavity is defined partially within the body and between the mounting sleeve and the threaded portion, wherein a free end of the central electrode extends into the precombustion cavity. A plurality of posts is disposed through the mounting sleeve at the threaded portion, each of the plurality of posts protruding at least partially into the chamber by a predetermined distance (d). An electrode having one or more limbs is connected to the free end of the central electrode, each of the one or more limbs extending into the precombustion cavity and being disposed at a respective gap from a corresponding one of the plurality of posts, each respective gap having a predetermined length (D). A cap is disposed to close an open end of the precombustion cavity, the cap being connected to the threaded portion and having a cupped end forming one or more openings.

In another aspect, the disclosure describes a spark plug for an internal combustion engine. The spark plug includes a body having a centerline extending along an axial direction, the body including a terminal post adapted for connection to a source of electrical potential. A central electrode is electrically connected to the terminal post. A threaded portion is connected to the terminal post via a mounting sleeve, the threaded portion forming a bore having an open end opposite the terminal post in the axial direction. A precombustion cavity is defined in the body in an area opposite the terminal post and within and occupying the bore in the threaded portion. A cap is connected to the threaded portion and closes the open end. A free end of the central electrode extends into the precombustion cavity and is connected to an electrode having one or more limbs, each of the one or more limbs extending into the precombustion cavity. A plurality of posts is disposed through the threaded portion and protrudes into the chamber by a predetermined distance (d). Each of the plurality of posts is disposed at a respective gap from a corresponding one of the one or more limbs, each respective gap having a predetermined length (D).

### BRIEF DESCRIPTION OF THE DRAWINGS

FIG. 1 is a chamber spark plug in accordance with the disclosure.

FIG. 2 is an enlarged cross section from a side perspective of a chamber of a first embodiment for a spark plug in accordance with the disclosure.

FIG. 3 is an enlarged cross section from a side perspective of a chamber of a second embodiment for a spark plug in accordance with the disclosure.

FIG. 4 is an enlarged cross section from a side perspective of a chamber of a third embodiment for a sparkplug in accordance with the disclosure.

FIG. 5 is an enlarged cross section from an end perspective of the chamber of the spark plug embodiment shown in FIG. 4.

### DETAILED DESCRIPTION

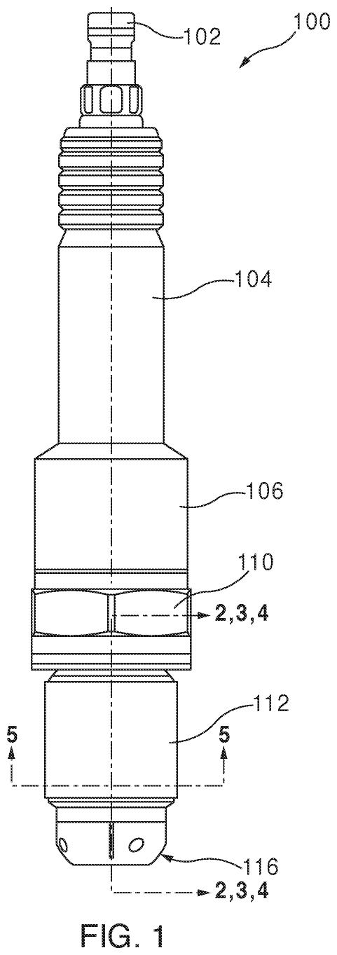

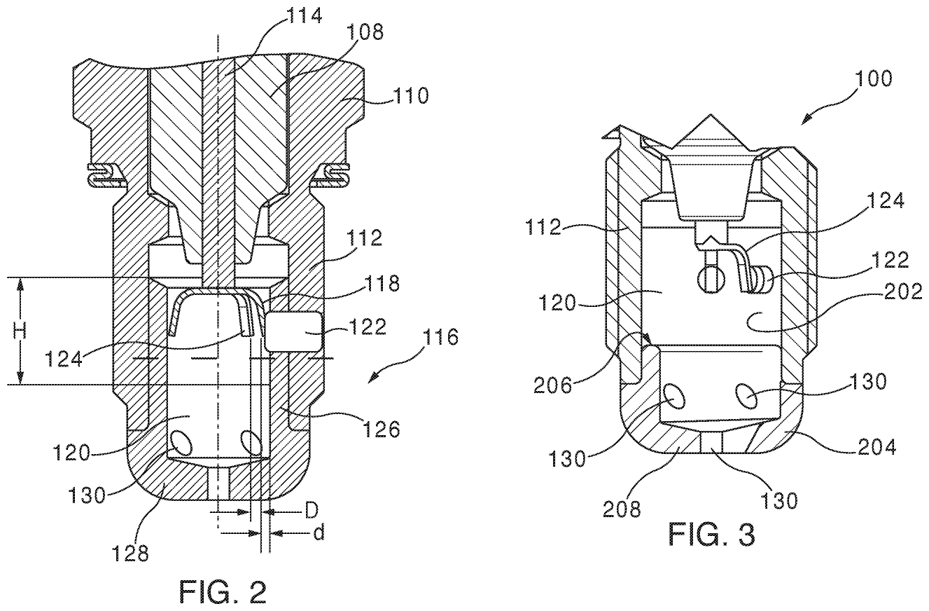

The present disclosure is applicable to internal combustion engines and, more particularly, to engines operating with a gaseous fuel, which may or may not additionally include a precombustion chamber that is separate from a main combustion chamber and also separate from any cavities formed within the body of a spark plug disposed in communication with the engine combustion chamber, as described below. The spark plug in accordance with the disclosure can be used either within a precombustion chamber of an engine, or directly into a main combustion chamber of the engine, for reliably igniting a mixture of air with a gaseous fuel within an engine combustion and/or precombustion chamber. FIG. 1 is an outline view from a side perspective of a spark plug 100 in accordance with the disclosure. The spark plug 100 includes a terminal post 102 at one end, onto which an electrical connector (not shown) that carries a high electrical potential during operation can be connected in the known fashion. The terminal post 102 is disposed at an end of an insulator 104, which is made from an electrically insulative material such as ceramic and can surround and enclose other internal electrical components of the spark plug 100 such as an internal portion or extension of the terminal post 102, a suppressor, a spring and/or the like in the traditional spark plug arrangement of internal electrical components. The insulator 104 may include an enlarged, lower section 106, which encloses an internal insulator 108 as shown, for example, in FIG. 2. The internal insulator 108 electrically isolates a mounting sleeve 110 that includes a hex profile, is made from a metal or other electrically conductive material, and includes a threaded portion 112, with which the spark plug 100 can be connected to a mating threaded opening of an engine.

A center electrode 114 is electrically connected to the terminal post 102 and extends through the spark plug 100 and into a precombustion chamber portion 116. During operation, an electrical potential provided through the terminal post 102 is transferred through the spark plug 100 and onto an internal terminal, which provides a spark when grounded to the engine via the threaded portion 112, in the typical fashion. The center electrode 114 is electrically insulated from the mounting sleeve 110 and from the threaded portion 112, which constitutes the mating ground electrode for the spark plug 100. The center electrode 114 is connected to a sparking electrode assembly 118, which is suspended within a precombustion chamber 120 defined within the precombustion chamber portion 116 of the spark plug 100. Ground electrode posts 122 are embedded into the sidewalls of the precombustion chamber 120 and extend by a distance, d, into the precombustion chamber 120 such that the posts 122 are at a predefined, gap distance D from tips formed at the free ends of branches 124 of the sparking electrode assembly 118.

In the present disclosure, the phrase “precombustion chamber” is used to refer to the cavity denoted by reference numeral 120 in the figures, but it should be appreciated that this nomenclature does not and need not refer to a precombustion chamber or “prechamber” of an engine; the spark plug 100 may be used directly in fluid contact with a main combustion chamber of an engine in place of a non-precombustion or “open spark” plug, and may alternatively be used within a precombustion chamber of an engine, which would place the spark plug 100 in indirect fluid contact with the engine's main combustion chamber.

The precombustion chamber 120 or, simply, the chamber 120, is formed as a generally cylindrical cavity within a hollow cylindrical wall that is formed as part of a body of the spark plug 100 within the threaded portion 112 and extending axially above and below the threaded portion 112 such that a volume of the chamber 120 is maximized. In the embodiment illustrated in FIG. 2, the threaded portion 112 is formed within two concentrically cooperating elements—an outer cup or shell formed by the threaded portion 112 and an inner cup 126 that is open at one end, which faces the branches 124, and closed at a bottom end 128, and which forms an end of the chamber 120. At or around the bottom end 128, one or more openings 130 are formed that allow for direct fluid communication between the chamber 120 with the environment external to the spark plug 100, for example, the combustion chamber of an engine in which the spark plug is installed.

In the embodiment shown in FIG. 2, the inner cup 126 extends upwardly in an axial direction to a height, H, that is above the connection point of the center electrode 114 and the branches 124. The inner surface of the inner cup 126 is reamed to a desired and/or controlled dimension to provide, along with dimensional control on the branches 124, the desired distances d and D between the branches 124 and the posts 122. It should be noted that, while the posts 122 are shown as extending through the walls of both the inner and outer walls of the threaded portion 112 and the inner cup 126, the posts 122 may be shorter and extend only through the lateral wall of the inner cup 126.

Certain alternative embodiments of the spark plug 100 are shown in FIGS. 3, 4 and 5. In these embodiments, features and structures that are the same or similar to corresponding features and structures described in relation to the embodiment shown in FIG. 2 are denoted by the same reference numerals as previously used for simplicity, but it should be appreciated that at least some differences may exist, as described below.

In a first alternative or second embodiment of the spark plug 100 is shown in FIG. 3. This illustration represents an alternative embodiment for the spark plug 100 from a similar view as that of FIG. 2, it can be seen that the outer cup or threaded portion 112 includes an inner surface 202 that defines a portion of the chamber 120, at least along an area surrounding the branches 124. The inner cup is formed more like a cap 204, which includes a cylindrical wall 206 and a convex end cap 208 that forms the end of the chamber 120 and forms the openings 130. The wall 206 fits within an inner diameter of the threaded portion 112 to attach the cap 204 to the spark plug 100 and to also define a lower boundary of the chamber 120. In this construction, relative to the construction shown in FIG. 2, the volume and internal size of the chamber 120 is increased, which permits a larger quantity of combustion-sustaining compounds to enter and which thus promotes a more stable flame. In the embodiment of FIG. 3, the posts 122 are connected and extend through the threaded portion 112 in an area above the wall 206.

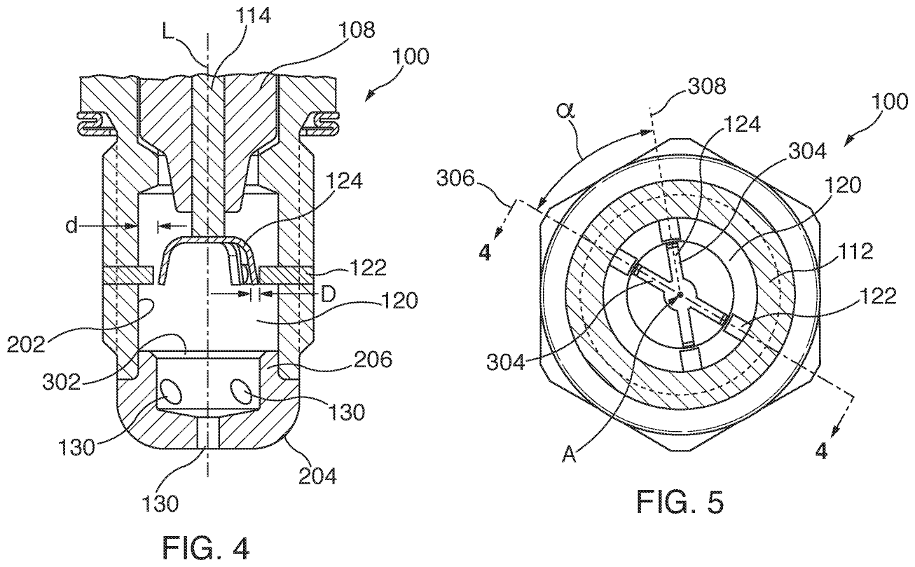

Another or a third embodiment for the spark plug 100 is shown from two different perspectives in cross section in FIGS. 4 and 5. In this embodiment, which is similar to the embodiment shown in FIG. 3, the cap 204 includes a flat, annular top surface of the wall 206 with an internal chamfer 302. When the embodiments in FIGS. 3 and 4 are compared, it can be seen that the height of the wall 206 in the embodiment of FIG. 4 is shorter than the corresponding height of the wall 206 in the embodiment of FIG. 3, to even further enlarge the volume of the chamber 120. Further, the chamfer 302, facilitates the swirling motion of material entering and exiting the chamber 120 through the openings 130.

As shown in FIG. 5, the branches 124 include four separate limbs 304 arranged in coplanar pairs. Each pair of limbs 304 is arranged along a first plane 306 and a second plane 308, which are disposed at an angle, a, and coincide along an axis, A, that also coincides with the centerline, L, of the spark plug 100. In the embodiment shown, the angle α is about 45 degrees.

### INDUSTRIAL APPLICABILITY

This disclosure generally relates to internal combustion engines and, more specifically, to one or more embodiments for sparkplugs for use with engines operating with a gaseous fuel, which can be used alone or in addition to other fuels such as diesel to operate the engine in at least some operating conditions. The gaseous fuel used to operate the engine may be natural gas, liquefied petroleum gas (LPG), biogas, or any other combustible fuel, which is provided upstream of an engine cylinder, in mixture with air, or directly into the cylinder of the engine.

In certain engines operating with gaseous fuel, and air/fuel mixture or ratio that is provided in the engine cylinders may be lean, and ignition may be provided by a spark that is generated within a chamber in the presence of a combustible mixture containing air and fuel. A burning combustible mixture that is ignited within the chamber is then provided through openings into the main combustion chamber of the engine to propagate a flame and complete the burning of fuel within the engine combustion chamber. The embodiments for spark plugs described herein are advantageously constructed to maximize the volume or internal cavity size of the chamber to provide a more reliable ignition under a variety of engine operating conditions such as conditions of low ambient temperature, high altitude and others, in which reliable combustion under existing spark plug configurations may not generally be as reliable.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

1. A spark plug for an internal combustion engine, comprising:
a body that includes a terminal post adapted for connection to a source of electrical potential;
a central electrode that is electrically connected to the terminal post;
a mounting sleeve that includes a threaded portion, wherein the central electrode extends at least partially through the mounting sleeve;
an internal insulator disposed between at least a portion of the central electrode and the mounting sleeve;
a precombustion cavity defined partially within the body and between the mounting sleeve and the threaded portion, wherein a free end of the central electrode extends into the precombustion cavity;
a plurality of posts disposed through the mounting sleeve at the threaded portion, each of the plurality of posts protruding at least partially into the chamber by a predetermined distance (d);
an electrode having one or more limbs connected to the free end of the central electrode, each of the one or more limbs extending into the precombustion cavity and being disposed at a respective gap from a corresponding one of the plurality of posts, each respective gap having a predetermined length (D); and
a cap disposed to close an open end of the precombustion cavity, the cap being connected to the threaded portion and having a cupped end forming one or more openings.

2. The spark plug of claim 1, wherein the cap includes a cylindrical wall forming a cylindrical sleeve that extends from the cupped end into the threaded portion at a location that overlaps the plurality of posts, and wherein the posts further extend through the cylindrical sleeve.

3. The spark plug of claim 2, wherein the cylindrical sleeve has an internal section that is reamed to a desired dimension at an axial location that at least overlaps the one or more limbs of the electrode.

4. The spark plug of claim 1, wherein the cap further includes a cylindrical wall that matingly engages an inner diameter of a cylindrical bore formed in the threaded portion and defines the chamber at least partially.

5. The spark plug of claim 4, wherein the cylindrical wall extends to an axial length within the chamber with respect to a centerline of the spark plug that does not overlap the electrode.

6. The spark plug of claim 4, wherein the cylindrical wall has a flat, annular end surface and an inner, concave surface.

7. The spark plug of claim 6, wherein the cap further includes a chamfer formed between the flat, annular end surface and the concave surface.

8. The spark plug of claim 1, wherein the electrode includes four limbs.

9. The spark plug of claim 8, wherein the four limbs are arranged in two pairs, each pair including two limbs that are aligned and coplanar in a radial orientation around a centerline of the spark plug, wherein first and second planes are defined by the two pairs of limbs.

10. The spark plug of claim 9, wherein the first and second planes are disposed at an angle (α) relative to one another and coincide along the centerline of the spark plug.

11. The spark plug of claim 9, wherein the plurality of posts consists of four posts, each of the four posts being aligned in the radial orientation with each of the four limbs.

12. A spark plug for an internal combustion engine, the spark plug comprising:
a body having a centerline extending along an axial direction, the body including a terminal post adapted for connection to a source of electrical potential;
a central electrode that is electrically connected to the terminal post;
a threaded portion connected to the terminal post via a mounting sleeve, the threaded portion forming a bore having an open end opposite the terminal post in the axial direction;
a precombustion cavity defined in the body in an area opposite the terminal post, the precombustion cavity defined within and occupying the bore in the threaded portion;
a cap connected to the threaded portion and closing the open end;
wherein a free end of the central electrode extends into the precombustion cavity and is connected to an electrode having one or more limbs, each of the one or more limbs extending into the precombustion cavity;
a plurality of posts disposed through the threaded portion and protruding into the chamber by a predetermined distance (d);
wherein each of the plurality of posts is disposed at a respective gap from a corresponding one of the one or more limbs, each respective gap having a predetermined length (D).

13. The spark plug of claim 12, wherein the cap includes a cylindrical wall forming a cylindrical sleeve that extends into the bore of the threaded portion at a location that overlaps the plurality of posts, and wherein the posts further extend through the cylindrical sleeve.

14. The spark plug of claim 13, wherein the cylindrical sleeve has an internal section that is reamed to a desired dimension at an axial location that at least overlaps the one or more limbs of the electrode.

15. The spark plug of claim 12, wherein the cap further includes a cylindrical wall that matingly engages an inner diameter of the bore formed in the threaded portion and defines the chamber at least partially.

16. The spark plug of claim 15, wherein the cylindrical wall extends to an axial length within the chamber bore with respect to a centerline of the spark plug that does not overlap the electrode.

17. The spark plug of claim 15, wherein the cylindrical wall has a flat, annular end surface and an inner, concave surface.

18. The spark plug of claim 17, wherein the cap further includes a chamfer formed between the flat, annular end surface and the concave surface.

19. The spark plug of claim 12, wherein the electrode includes four limbs.

20. The spark plug of claim 19, wherein the four limbs are arranged in two pairs, each pair including two limbs that are aligned and coplanar in a radial orientation around a centerline of the spark plug, wherein first and second planes are defined by the two pairs of limbs, and wherein the two planes are disposed at an angle (α) relative to one another and coincide along the centerline of the spark plug.
